(19) United States
(12) Patent Application Publication
(10) Pub. No.: US 2024/0264639 A1
(43) Pub. Date: Aug. 8, 2024

(54) DISPLAY APPARATUS

(71) Applicant: East Meets West Inc., La Verne, CA (US)

(72) Inventors: Jose Daniel Reiff, La Verne, CA (US); Shasha Qi, La Verne, CA (US); Bill Ryczek, La Verne, CA (US)

(73) Assignee: East Meets West Inc., La Verne, CA (US)

(21) Appl. No.: 18/434,643

(22) Filed: Feb. 6, 2024

Related U.S. Application Data
(60) Provisional application No. 63/443,509, filed on Feb. 6, 2023.

(51) Int. Cl. G06F 1/16

(52) U.S. Cl. CPC G06F 1/1679; G06F 1/1616

(57) ABSTRACT

A display apparatus is disclosed, the display apparatus a lid cover hingedly coupled to a container. The lid cover has a spring bias pushing the display apparatus into an open state. A latch is configured to engage with the lid cover and hold the lid cover into a closed state. A display screen is coupled to the lid cover such that while in the closed state the display screen is concealed from external view. While in the open state, the display screen is upright and externally viewable. An actuator is mechanically coupled to the latch such that upon activation of the actuator, the latch is configured to disengage from lid cover, thereby converting the display apparatus from a closed state to an open state.

### CROSS-REFERENCE TO RELATED APPLICATIONS

This application claims benefit of priority with U.S. Provisional Application Ser. No. 63/443,509, filed Feb. 6, 2023; the entire contents of which are hereby incorporated by reference.

### BACKGROUND

### Field of the Invention

This disclosure relates to a display apparatus and more particularly to a display apparatus having a displayed screen disposed within a container thereof.

Description of the Related Art

Sending greeting cards to loved ones is a common tradition. Whether the greeting card is standalone or attached to a gift, greeting cards are used to convey particular and personal messages to the receiver of said greeting cards. With the ubiquity of computers and social media, physical greeting cards have become less popular. Many digital equivalents now exist which can include personalized animations or video. However, these digital greeting cards can be less desirable due to a lack of physicality and originality.

There is an ongoing need for an apparatus to provide a novel means of providing a greeting message.

### SUMMARY

A display apparatus is disclosed, the display apparatus comprises a container having an upper rim formed by a body. The body comprises a plurality of panels. A lid cover is hingedly coupled to the container, the lid cover having a top surface and a bottom surface opposite the top surface. The display apparatus further comprises a display screen coupled to the bottom surface of the lid cover such that while in a closed state the display screen is concealed from external view. An actuator is coupled to the container and is mechanically coupled to a latch. Upon activation of the actuator, the latch is configured to disengage from the lid cover while in the closed state. A spring bias integrated with the lid cover is configured to push the lid cover into an open state, thereby making the display screen externally viewable.

### BRIEF DESCRIPTION OF THE DRAWINGS

Other features, combinations, and embodiments will be appreciated by one having the ordinary level of skill in the art upon a thorough review of the following details and descriptions, particularly when reviewed in conjunction with the drawings, wherein:

FIG. 1 shows a perspective view of a display apparatus in a closed state in accordance with a first illustrated embodiment;

FIG. 2 shows a perspective view of the display apparatus in an open state according to the first illustrated embodiment;

FIG. 3 shows a perspective view of the display apparatus in accordance with a second illustrated embodiment;

FIG. 4 shows a perspective view of the display apparatus in accordance with a third illustrated embodiment;

FIG. 5 shows a perspective view of the display apparatus in accordance with a fourth illustrated embodiment;

FIG. 6 shows a side view of the display apparatus according to the fourth illustrated embodiment;

FIG. 7 shows an exploded view of the display apparatus according to the fourth illustrated embodiment; and

FIG. 8 shows a perspective view of a crank assembly in accordance with an illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “display screen” means any device configured to visually transmit videos including projectors, augmented reality displays, and conventional flat screens such as LED displays and LCD monitors.

Unless explicitly defined herein, terms are to be construed in accordance with the plain and ordinary meaning as would be appreciated by one having skill in the art.

### General Description of Embodiments

In one general embodiment, a display apparatus is disclosed. The display apparatus comprises a container having an interior enclosed by a body, the body comprising a plurality of panels that form an upper rim. A lid cover is hingedly coupled to the container. The lid cover comprises a top surface and a bottom surface opposite the top surface. Coupled to the bottom surface is a display screen. The display apparatus further comprises a latch configured to couple to the lid cover for holding the lid cover in a closed state, wherein the display screen is concealed within the container while in the closed state. An actuator is disposed on the container where the actuator is mechanically coupled to the latch such that upon activation of the actuator the latch is configured to disengage from the lid cover. A spring bias is integrated within the lid cover wherein the spring bias pushes the lid cover into an open state such that the display screen is externally viewable.

In some embodiments, the actuator may further comprise a crank extending from the container.

In some embodiments, the apparatus may further comprise an inner liner disposed within the interior of the container, the inner liner having a hollow center. The apparatus may further comprise a removable insert configured to nest within the hollow center of the inner liner. The removable insert may comprise a ring holder.

In some embodiments, the apparatus may further comprise a top panel coupled to the interior of the body and engaged to each of the plurality of panels. A gap may be between the the upper rim of the body and the top panel.

In some embodiments, the plurality of panels may further comprise a front panel, a rear panel opposite the front panel, a first side panel, and a second side panel opposite the first side panel, wherein the lid cover is configured to hingedly rotate about the rear panel. The interior of the container may be accessible by a drawer aperture, the drawer aperture being disposed on the front panel. The apparatus may further comprise a slidable drawer configured to through the drawer aperture and nest within the interior of the container. In some embodiments, the slidable drawer is configured to automatically slide open after the lid cover has converted to the open state.

In some embodiments, the apparatus may further comprise a tether, the tether coupled to both the lid cover and the interior of the container.

In some embodiments, the display screen further may comprise a USB port.

In some embodiments, the apparatus may further comprise a plurality of tabs coupled to the container, the plurality of tabs each comprising a slot.

In some embodiments, the lid cover may further comprise a plurality of lid portions, wherein each of the plurality of lid portions is independently coupled to the upper rim of the container. The display screen may be coupled to one of the plurality of lid portions.

In some embodiments, the apparatus may further comprise a speaker for supplementing audio with a corresponding video played on the display screen. The speaker may be integrated with the display screen or separate from the display screen.

Generally, the display apparatus further comprises a battery, memory, and a processor such that one or more video files can be uploaded to the memory and played with the display screen upon execution by the processor. In some embodiments, the processor may be triggered by at least one of the actuator, latch, or lid cover for initiating playtime of the display screen.

In some embodiments, the display apparatus is configured to product a musical sound upon activation of the actuator. The musical sound can be produced directly by a crank assembly or an audio transducer electrically coupled to the crank assembly.

In another general embodiment, a display apparatus is disclosed. The display apparatus comprises a container having an interior enclosed by a body, the body comprising a plurality of panels that form an upper rim. A lid cover is hingedly coupled to the container, the lid cover comprising a top surface and a bottom surface opposite the top surface. A display screen is coupled to the bottom surface of the lid cover. The apparatus further comprises a latch configured to couple to the lid cover for holding the lid cover in a closed state, wherein the display screen is concealed within the container while in the closed state. A crank extending from the container is mechanically coupled to the latch such that upon rotation of the crank the latch is configured to disengage from the lid cover. A spring bias is integrated within the lid cover wherein the spring bias pushes the lid cover into an open state such that the display screen is externally viewable. The apparatus further comprises an inner liner disposed within the interior of the container, the inner liner having a hollow center, and a removable insert configured to nest within the hollow center of the inner liner.

In some embodiments, the removable insert may comprise a ring holder.

In some embodiments, the apparatus may further comprise a tether coupled to both the lid cover and the interior of the container.

In another general embodiment, a display apparatus is disclosed. The display apparatus comprises a container having an interior enclosed by a body, the body comprising a plurality of panels that form an upper rim, the plurality of panels further comprising a front panel, a rear panel opposite the front panel, a first side panel, and a second side panel opposite the first side panel. A top panel is coupled to the interior of the body and engaged to each of the plurality of panels, wherein a gap is formed between the top panel and the upper rim. A lid cover is hingedly coupled to the container at the rear panel, the lid cover comprising a top surface and a bottom surface opposite the top surface. A display screen is coupled to the bottom surface of the lid cover.

The apparatus further comprises a latch configured to couple to the lid cover for holding the lid cover in a closed state, wherein the display screen is concealed within the container while in the closed state. A crank extends from the container, the crank being mechanically coupled to the latch such that upon rotation of the crank the latch is configured to disengage from the lid cover. With a spring bias integrated within the lid cover, the lid cover is pushed into an open state such that the display screen is externally viewable. The interior of the container is accessible by a drawer aperture disposed on the front panel, the drawer aperture being configured to receive a slidable drawer.

In some embodiments, the apparatus may further comprise a slidable drawer configured to slide through the drawer aperture and nest within the interior.

In some embodiments, the apparatus may further comprise a tether coupled to both the lid cover and the interior of the container.

### Manufacturing

Each of the components of the display apparatus described herein may be manufactured and/or assembled in accordance with the conventional knowledge and level of a person having skill in the art.

Generally, the container is made of plastic, paper, or cardboard. Materials such as metal and wood may also be utilized. The container can be fabricated in accordance with the level and knowledge of one having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

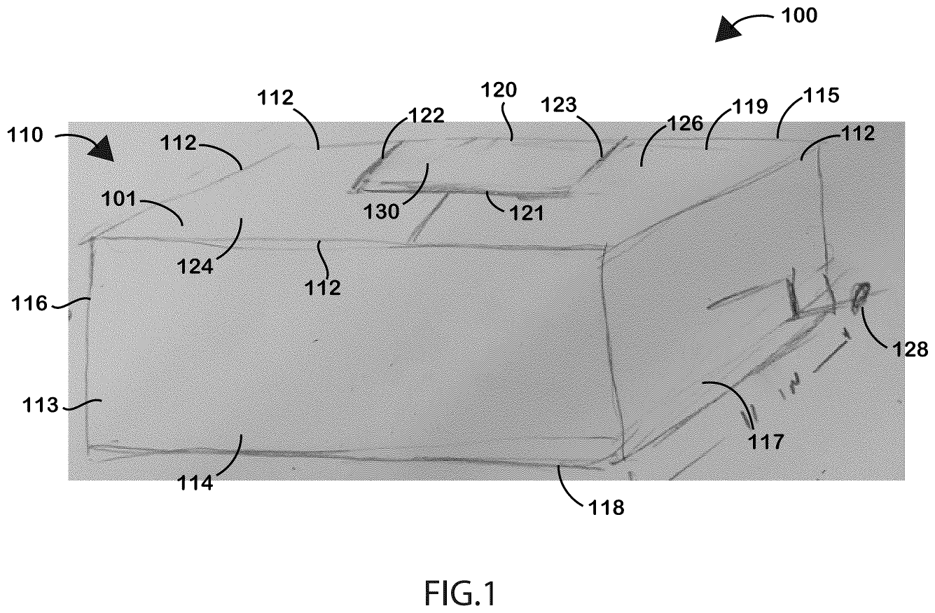

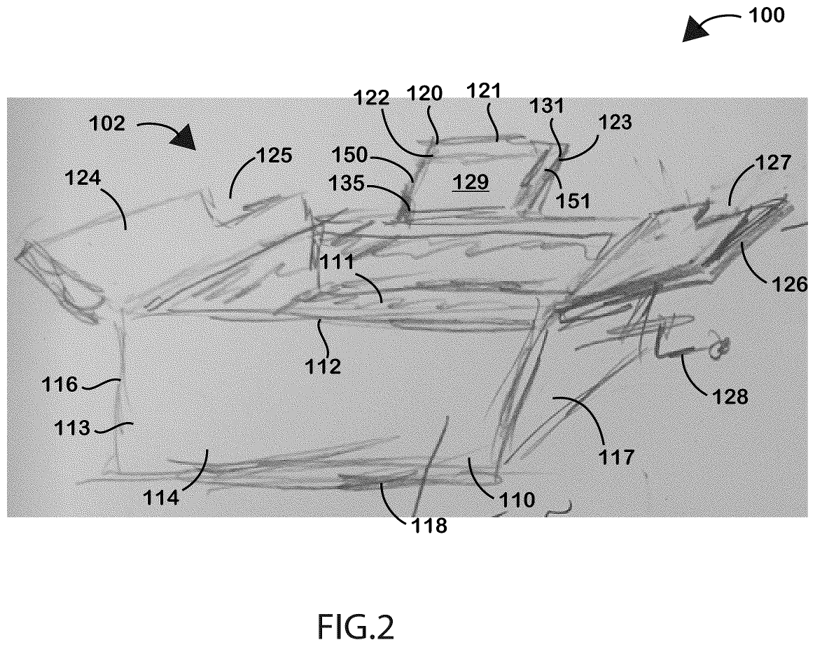

Now turning to the drawings, FIG. 1 shows a perspective view of a display apparatus (100) in a closed state (101) in accordance with a first illustrated embodiment. The display apparatus comprises a container (110) having an interior (FIG. 2; 111) enclosed by a body (113), a lid cover (119), and a closed bottom section (118). The body comprises a plurality of panels, namely a front panel (114), a rear panel (115) opposite the front panel, a first side panel (116), and a second side panel (117) opposite the first side panel such that the front and rear panels are each coupled to both the first and second side panels. The lid cover is coupled to an upper rim (112) formed by the plurality of panels. A crank (128) is coupled to second side panel, The crank is configured to rotate, and upon a sufficient number of rotations, cause the lid cover to hingedly open from the upper rim and exposing the interior of the container. Disposed within the interior is a display screen (not shown) that is configured to move from a position entirely within the container to a position where at least a portion of the display screen is disposed outside the container and configured for external view.

As shown, the lid cover (119) comprises a plurality of lid portions. The plurality of lid portions includes a central portion (120), a first lateral portion (124), and a second lateral portion (126). The central portion is hingedly coupled to the upper rim (112) of the rear panel (115). The first lateral portion is hingedly coupled to the upper rim at the first side panel (116). The second lateral portion is hingedly coupled to the upper rim at the second side panel (117). The central portion includes a perimeter having a top boundary (121), a first side boundary (122), and a second side boundary (123) opposite the first side boundary. While the display apparatus (100) is in the closed state (101), the first lateral portion abuts both the first side boundary and a portion of the top boundary. Additionally, while in the closed state, the second lateral portion abuts both the second side boundary and a portion of the top portion. Additionally, the first lateral portion abuts the second lateral portion while in the closed state.

The lid cover (119) is configured to be maintained in the closed state (101) with a locking mechanism. The locking mechanism is configured to disengage from the lid cover after a sufficient number of rotations of the crank (128), thereby causing the lid cover to hingedly open from a spring bias (135) on the lid cover. The spring bias can be contained within each hinge coupling of the lid cover. In some embodiments, the locking mechanism includes a latch configured to engage with the lid cover and maintain the lid cover in the closed state. The crank is coupled to a rotational element disposed within the container. The rotational element includes a tab configured to engage with the latch, thereby causing the latch to disengage from the lid cover. With the spring bias, the lid cover is configured to the open state when detached from the locking mechanism. Actuation of the lid cover opening is illustrated with the crank coupled to the body. In other embodiments, actuation can be achieved by handle, button, switch, or the like.

FIG. 2 shows a perspective view of the display apparatus (100) in an open state (102) according to the first illustrated embodiment. The display apparatus comprises a container (110) having a body (113) with a bottom section (118) on one side, and access to an interior (111) of the container on an opposite side. The body includes a front panel (114), a rear panel (115), a first side panel (116), and a second side panel (117) wherein each of the panels forms an upper rim (112) of the container. Hingedly coupled to the upper rim is a lid cover (119).

The lid cover (119) includes a central portion (120), a first lateral portion (124), and a second lateral portion (126). The central portion is hingedly coupled to the rear panel (115), and the first and second lateral portions are hingedly coupled to the first and second side panels (116; 117), respectively. The first and second lateral portions are configured to rotate in opposite directions from each other. A display screen (129) is coupled to a bottom surface (131) of the central portion such that when the central portion rotates upward the display screen moves from a position inside the container (110) at the interior (111) to a position outside the container.

The first lateral portion (124) includes a first cutout (125) and the second lateral portion (126) includes a second cutout (127). While in a closed state (101), the central portion (120) abuts both the first cutout and the second cutout. Having the display screen (129) coupled to the bottom surface (131) of the central portion allows a smaller display screen size to be used. In some embodiments, the central portion includes a stopper to keep the central portion at a particular desired angle while in the open state.

The lid cover (119) is held in the closed state (101) by a locking mechanism, such as a mechanical latch. In some embodiments, the mechanical latch is only engaged with the central portion (120) with the first and second lateral portions (124; 126) being held down by the central portion. Once the locking mechanism disengages from the central portion, a spring bias can cause the central portion to rotate upward which subsequently allows the first and second lateral portions to also rotate upward due to independent spring bias forces applied to each lateral portions. The locking mechanism disengagement from the central portion is actuated by the crank (128).

The display screen (129) is electrically coupled to memory (150) and at least one processor (151). Based on execution of the processor with the display screen, one or more video files contained within the memory can be played on the display screen. Video files can be managed by an external device such as a smartphone or a computer. The display apparatus (100) may further comprise a speaker to provide audio from the one or more video files. A battery source is disposed within the interior (111) of the container (110) to supply power to the processor and the display screen. The battery can be a primary battery which requires periodic battery changes, or the battery may comprise a secondary battery with an included charging circuitry.

In some embodiments, the battery is electrically coupled to the crank (128) wherein upon rotation of the crank the battery can be charged momentarily. Recharging the battery from rotations of the crank may occur while the display apparatus is in the closed state. The lid cover (119) is configured to convert to the open state when the battery has received a sufficient charge to provide power to the display screen and other peripherals for a desirable amount of time.

The one or more video files can be uploaded to the memory (150) by various means. Uploading can be achieved via wire and a data port, such as a USB port electrically coupled to the memory and processor (151). Other means may include uploading the one or more video files using wireless technology, such as Wi-Fi, Bluetooth, NFC, and the like.

As shown, the display screen (129) changes position from the closed state (101) to the open state (102) via rotational movement from the central portion (120) of the lid cover (119).

In other embodiments, the rotational movement can be achieved wherein the display screen is decoupled from the central portion. For example, the display screen may face downwards and be hingedly coupled to the interior (111) of the container (110) with a spring bias coupling. The spring bias causes the display screen to rotate upwards toward the rear panel (115) when the lid cover converts to the open state and allows the display screen to be externally viewable. The display screen may include an extension coupled between the display screen and the spring bias coupling within the interior. The extension allows some or all of the display screen to be elevated above the body (113) to prevent interference from viewing the display screen. The display screen can be coupled to a myriad of locations within the interior including the bottom section (118) or rear panel.

In some embodiments, movement of the display screen (129) comprises predominantly translational movement rather than rotational movement. The display screen can be coupled to a translational mechanism that translates the display screen upwards from inside the container (110) to outside the container. The display screen can be positioned in a myriad of locations within the interior (111). In one embodiment, the translational mechanism comprises a spring coupled to the display screen and further coupled to the bottom section (115) of the container. The display screen may be positioned upright and configured to rest against the bottom surface (131) of the lid cover while in the closed state (101), thereby causing compression of the spring. In another embodiment, the translational mechanism can include sliding tracks disposed on the first and second side panels (116; 117). A spring bias from within the sliding tracks or outside the sliding tracks can cause the display screen to move vertically upward.

Movement of the display screen (129) can be either fast or slow as desired. A fast movement can be achieved with a sufficiently strong spring bias and can provide a surprise factor that can be found amusing and whimsical. A slow movement can be achieved by a myriad of ways as can be appreciated by one having skill in the art. In one embodiment, the display screen is mechanically coupled to the crank (128) such that upon rotation of the crank the display screen will move a proportional amount. Gear ratios can be optimized depending on how many crank rotations are desired to put the display screen into a final open state. Other mechanisms to cause a delay or slow movement of the display screen can also be utilized.

### Second Illustrated Embodiment

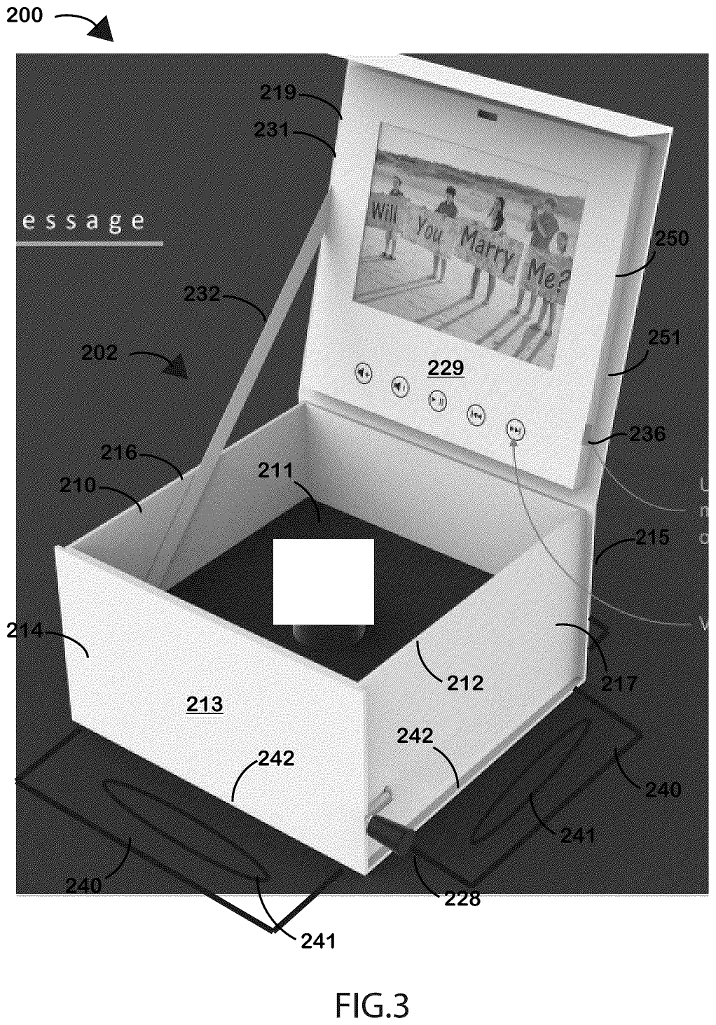

FIG. 3 shows a perspective view of the display apparatus (200) in accordance with a second illustrated embodiment. The display apparatus includes a container (210) having a body (213), the body comprises a front panel (214), a rear panel (215) opposite the front panel, a first side panel (216), and a second side panel (217) opposite the first side panel. The body extends from an upper rim (212) down to a lower rim (242). A lid cover (219) is hingedly coupled to the rear panel with a spring bias (235) for an open state (202). A display screen (229) is coupled to a bottom surface (231) of the lid cover. Memory (250) and a processor (251) are electrically coupled to the display screen. Coupled to the container at the lower rim are a plurality of tabs (240). The plurality of tabs extends from each of the front panel, rear panel, first side panel, and second side panel at the lower rim. Each of the plurality of tabs includes one or more slots (241). The one or more slots are configured to receive a string or ribbon to allow the display apparatus to be conveniently tied to a top of a gift box using conventional gift wrap materials.

The plurality of tabs (240) can be additional material extending from a bottom section of the container. Alternatively, the plurality of tabs may comprise the bottom section such that when the plurality of tabs is bent outward, as shown, the bottom region of the container is open and accessible.

The display apparatus (200) further comprises a crank (228) extending from the second side panel (217). The crank is configured to convert the lid cover (219) from a closed state to an open state (202) with the spring bias (235). The display screen (229) is coupled to the bottom surface (231) of the lid cover (219) such that when the display apparatus is in the closed state the display screen is disposed within an interior (211) of the container (210). After a certain number of rotations from the crank, the lid cover is configured to hingedly rotate with the spring bias putting the display screen elevated with an externally viewable position. The certain number of rotations can be fixed or randomized for each use in order to increase an element of surprise. A tether (232) is coupled to both the lid cover at the bottom surface and to the interior of the container. The tether is configured to prevent the lid cover from over rotation.

### Third Illustrated Embodiment

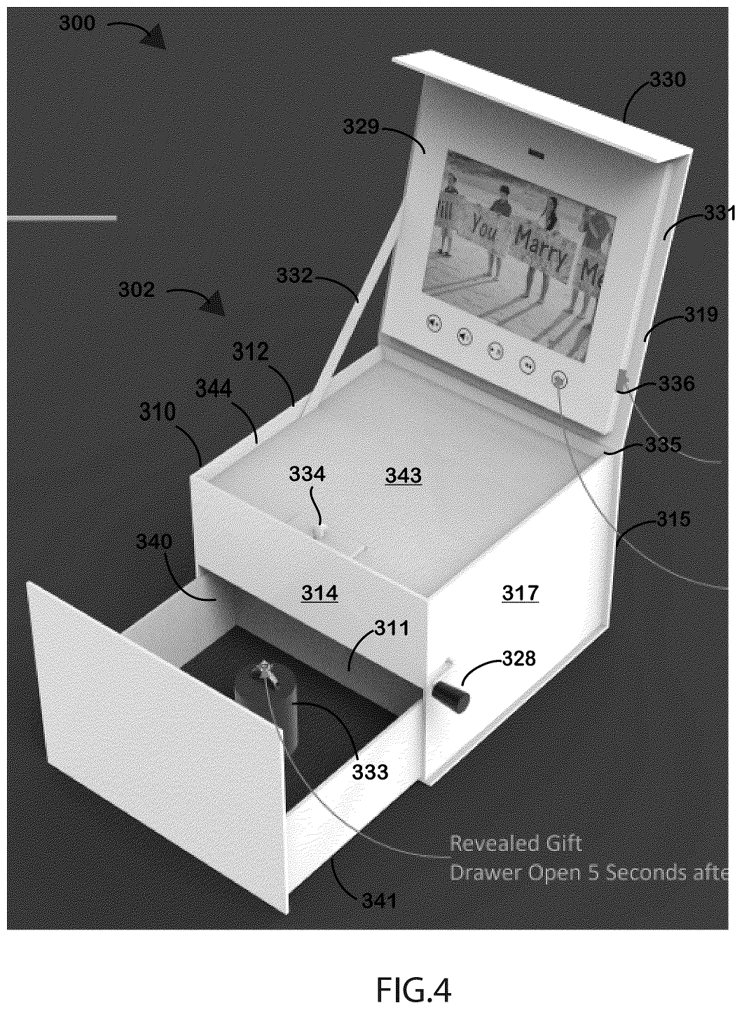

FIG. 4 shows a perspective view of the display apparatus (300) in accordance with a third illustrated embodiment. The display apparatus comprises a container (310) having a body (313) with a front panel (314), a rear panel (315), a first side panel (316), and a second side panel (317). An upper rim (312) is formed by each of the front panel, rear panel, first side panel, and second side panel. The container further comprises a top panel (343) coupled to an interior (311) thereof. A gap (344) is disposed between the top panel and the upper rim. Hingedly coupled to container is a lid cover having a top surface (330) and a bottom surface (331) opposite the top surface. A display screen (329) is couped to the lid cover at the bottom surface. The lid cover is configured to be in both an open state (302) or a closed state. While in the closed state, the display screen is configured to nest between the lid cover and the top panel within space provided by the gap. While in the open state, the display screen is upright and viewable for a user.

The container (310) further comprises interior (311) accessible by a drawer aperture (340) disposed on the front panel (314). A slidable drawer (341) is inserted within the drawer aperture and is configured to nest within the interior of the container. The slidable drawer can be used to hold various items including gifts and notes. As shown, the slidable drawer comprises a ring holder (333).

A crank (328) is coupled to the second side panel (317). The crank can alternatively be coupled to other locations of the container as can be appreciated by one having skill in the art. The crank is mechanically coupled to a latch (334) wherein rotating the crank causes the latch to disengage from the lid cover (319) while in the closed state causing the lid cover to transform into the open state (302) with a spring bias (335) integrated therein. A tether (332) can be utilized to ensure the lid cover is in a correct position while in the open state. In some embodiments, a crank assembly is coupled to each of the latch and crank to assist in opening the lid cover. The crank assembly can be disposed between the top panel (343) and the slidable drawer (341)

### Fourth Illustrated Embodiment

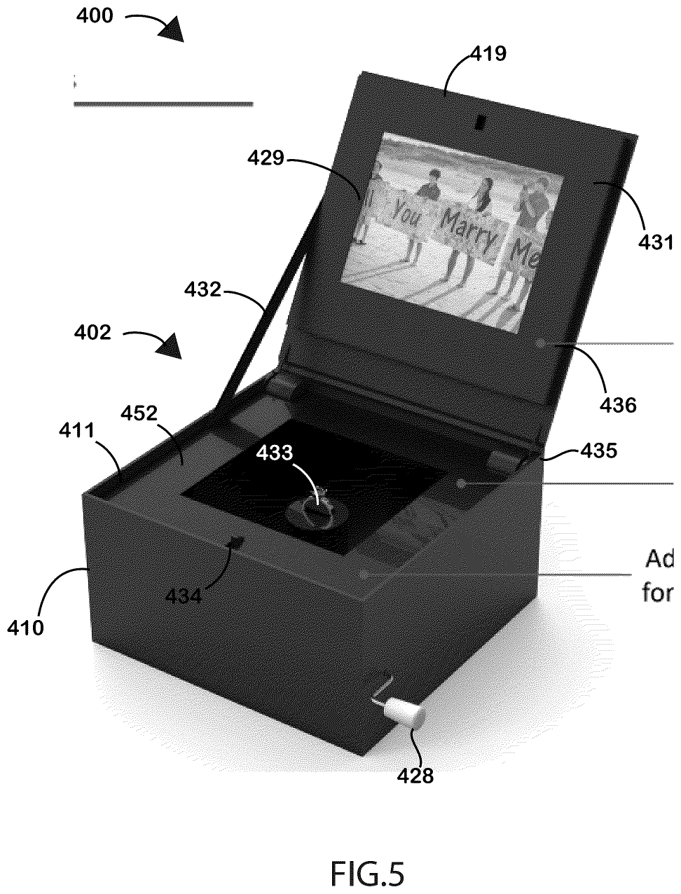

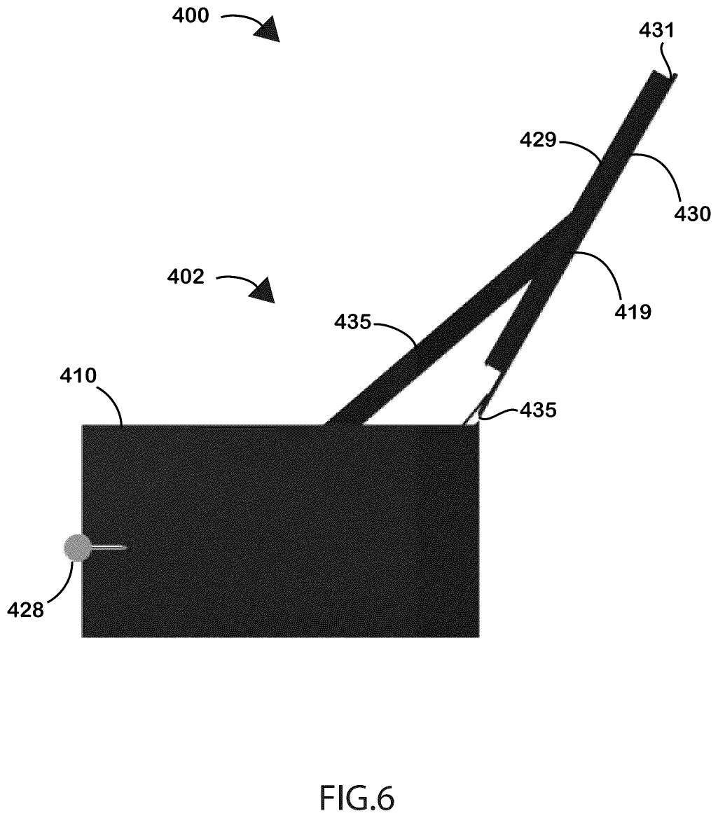

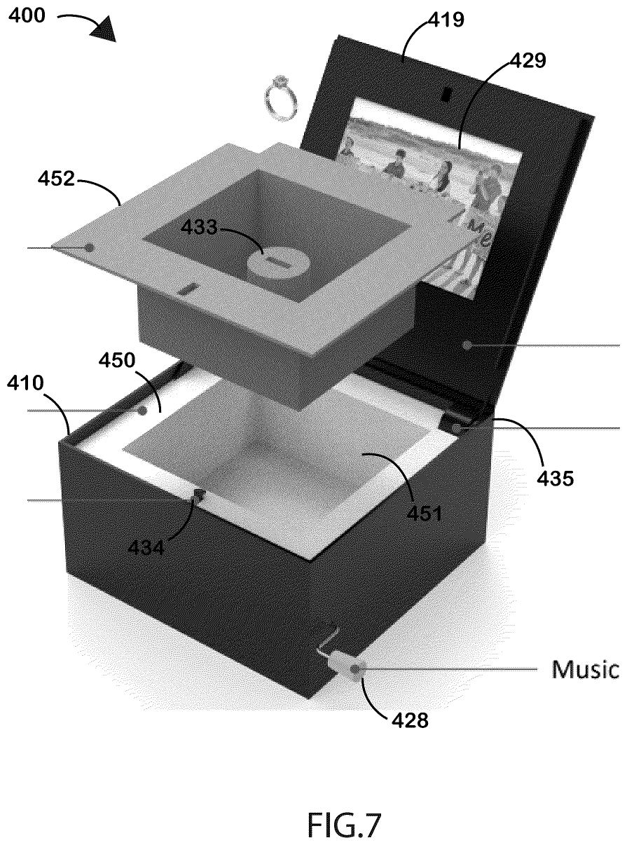

FIG. 5-7 show the display apparatus (400) in accordance with a fourth illustrated embodiment. The display apparatus comprises a lid cover (419) hingedly coupled to a container (410). The lid cover comprises a top surface (430) and a bottom surface (431) opposite the top surface. Coupled to the bottom surface is a display screen (429) configured to display videos. While the lid cover is in a closed state, the display screen is hidden from external view. When the lid cover converts to an open state (402), the display screen is in an upright position. The lid cover comprises a spring bias (435) that pushes the lid cover into the open state. The lid cover is held closed by engaging with a latch (434) disposed. To change the display apparatus from the closed state to the open state, a crank (428) is turned until the latch disengages from the lid cover, causing the lid cover to rotationally open from the spring bias. A tether (432) is coupled to the container and the lid cover and is used to prevent over rotation.

The container (410) comprises a inner liner (450) covering an interior (411) portion thereof. The inner liner can include materials such as foam. The inner liner comprises a hollow center (451) for receiving a removable insert (452), the removable insert configured for holding specific kinds of gifts. As shown, the removable insert comprises a ring holder (433) for presenting jewelry. Other detachable inserts can also be used for holder other sized and shaped gifts.

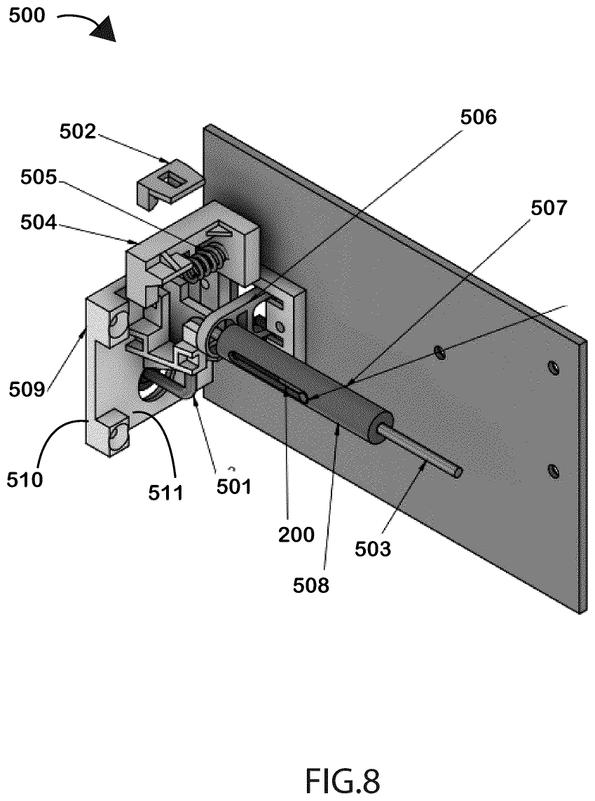

FIG. 8 shows a perspective view of a crank assembly (500). The crank assembly comprises a crank (501) extending through a bracket (509) from an outer side (510) to an inner side (511). A crank axle base (503) is coupled to the crank and extends away from the bracket at the inner side. The crank axle base is supported by a stabilizer (506) to allow for smooth turning of the crank. A guide (507) surrounds the crank axle base with a crank spring (508) disposed within the guide. The crank assembly further comprises lock tab (502) engaged with a button (504) and a button spring (505).

### FEATURE LIST

display apparatus (100; 200; 300; 400)
closed state (101)
open state (102; 202; 302; 402)
container (110; 210; 310; 410)
interior (111; 211; 311; 411)
upper rim (112; 212; 312)
body (113; 213; 313)
front panel (114; 214; 314)
rear panel (115; 315)
first side panel (116)
second side panel (117; 217; 317)
bottom section (118)
lid cover (119; 219; 319; 419)
central portion (120)
top boundary (121)
first side boundary (122)
second side boundary (123)
first lateral portion (124)
first cutout (125)
second lateral portion (126)
second cutout (127)
crank (128; 228; 328; 428)
display screen (129; 229; 329; 429)
top surface (130; 230; 330; 430)
bottom surface (131; 231; 331; 431)
spring bias (135; 235; 335; 435)
memory (150; 250)
processor (151; 251)
tether (232; 332; 432)
USB port (236; 336; 436)
plurality of tabs (240)
slot (241)
lower rim (242)
ring holder (333; 433)
latch (334; 434)
drawer aperture (340)
slidable drawer (341)
top panel (343)
gap (344)
inner liner (450)
hollow center (451)
removable insert (452)
crank assembly (500)
crank (501)
lock tab (502)
crank axle base (503)
button (504)
button spring (505)
stabilizer (506)
guide (507)
crank spring (508)
bracket (509)
outer side (510)
inner side (511)

What is claimed is:

1. A display apparatus, comprising:
a container having an interior enclosed by a body, the body comprising a plurality of panels that form an upper rim;
a lid cover hingedly coupled to the container, the lid cover comprising a top surface and a bottom surface opposite the top surface;
a display screen coupled to the bottom surface of the lid cover;
a latch configured to couple to the lid cover for holding the lid cover in a closed state, wherein the display screen is concealed within the container while in the closed state;
an actuator disposed on the container, the actuator mechanically coupled to the latch such that upon activation of the actuator the latch is configured to disengage from the lid cover; and
a spring bias integrated within the lid cover wherein the spring bias pushes the lid cover into an open state such that the display screen is externally viewable.

2. The display apparatus of claim 1, the actuator further comprising a crank extending from the container.

3. The display apparatus of claim 1, further comprising an inner liner disposed within the interior of the container, the inner liner having a hollow center.

4. The display apparatus of claim 3, further comprising a removable insert configured to nest within the hollow center of the inner liner.

5. The display apparatus of claim 4, wherein the removable insert comprises a ring holder.

6. The display apparatus of claim 1, further comprising a top panel coupled to the interior of the body and engaged to each of the plurality of panels.

7. The display apparatus of claim 6, further comprising a gap between the upper rim of the body and the top panel.

8. The display apparatus of claim 1, the plurality of panels further comprising a front panel, a rear panel opposite the front panel, a first side panel, and a second side panel opposite the first side panel, wherein the lid cover is configured to hingedly rotate about the rear panel.

9. The display apparatus of claim 8, wherein the interior of the container is accessible by a drawer aperture, the drawer aperture being disposed on the front panel.

10. The display apparatus of claim 9, further comprising a slidable drawer configured to through the drawer aperture and nest within the interior of the container .

11. The display apparatus of claim 1, further comprising a tether, the tether coupled to both the lid cover and the interior of the container.

12. The display apparatus of claim 1, the display screen further comprising a USB port.

13. The display apparatus of claim 1, further comprising a plurality of tabs coupled to the container, the plurality of tabs each comprising a slot.

14. The display apparatus of claim 1, the lid cover further comprising a plurality of lid portions, wherein each of the plurality of lid portions is independently coupled to the upper rim of the container.

15. The display apparatus of claim 14, wherein the display screen is coupled to one of the plurality of lid portions.

16. A display apparatus, comprising:
a container having an interior enclosed by a body, the body comprising a plurality of panels that form an upper rim;
a lid cover hingedly coupled to the container, the lid cover comprising a top surface and a bottom surface opposite the top surface;
a display screen coupled to the bottom surface of the lid cover;
a latch configured to couple to the lid cover for holding the lid cover in a closed state, wherein the display screen is concealed within the container while in the closed state;
a crank extending from the container, the crank mechanically coupled to the latch such that upon rotation of the crank the latch is configured to disengage from the lid cover;
a spring bias integrated within the lid cover wherein the spring bias pushes the lid cover into an open state such that the display screen is externally viewable;
an inner liner disposed within the interior of the container, the inner liner having a hollow center; and
a removable insert configured to nest within the hollow center of the inner liner.

17. The display apparatus of claim 16, wherein the removable insert comprises a ring holder.

18. The display apparatus of claim 16, further comprising a tether, the tether coupled to both the lid cover and the interior of the container.

19. A display apparatus, comprising:
a container having an interior enclosed by a body, the body comprising a plurality of panels that form an upper rim, the plurality of panels further comprising a front panel, a rear panel opposite the front panel, a first side panel, and a second side panel opposite the first side panel;
a top panel coupled to the interior of the body and engaged to each of the plurality of panels, wherein a gap is formed between the top panel and the upper rim;
a lid cover hingedly coupled to the container at the rear panel, the lid cover comprising a top surface and a bottom surface opposite the top surface;
a display screen coupled to the bottom surface of the lid cover;
a latch configured to couple to the lid cover for holding the lid cover in a closed state, wherein the display screen is concealed within the container while in the closed state;
a crank extending from the container, the crank mechanically coupled to the latch such that upon rotation of the crank the latch is configured to disengage from the lid cover; and
a spring bias integrated within the lid cover wherein the spring bias pushes the lid cover into an open state such that the display screen is externally viewable;
wherein the interior of the container is accessible by a drawer aperture disposed on the front panel, the drawer aperture configured to receive a slidable drawer.

20. The display apparatus of claim 19, further comprising a tether, the tether coupled to both the lid cover and the interior of the container.
